(19) United States
(12) Patent Application Publication
(10) Pub. No.: US 2012/0049785 A1
(43) Pub. Date: Mar. 1, 2012

(54) BATTERY MANAGEMENT SYSTEM

(75) Inventor: Atsushi TANAKA, Kariya-city (JP)

(73) Assignee: DENSO CORPORATION, Kariya-city (JP)

(21) Appl. No.: 13/192,603

(22) Filed: Jul. 28, 2011

(30) Foreign Application Priority Data
Aug. 27, 2010 (JP) 2010-191026

(51) Int. Cl. H02J 7/00

(52) U.S. Cl. 320/106

(57) ABSTRACT

A vehicle carries a battery as its power source. A battery control unit in the vehicle has an authentication unit. The authentication unit determines whether or not the battery is compliant. When the battery module is determined as non-compliant, a control unit restricts charge of the battery. Under a restricted condition of charging, use of the non-compliant battery is restricted. A user can acquire a permission to charge from a server of an administrative organization when the user registers required information from an input terminal. When the permission to charge is granted, the non-compliant battery can be charged. Therefore, user convenience is improved.

### CROSS REFERENCE TO RELATED APPLICATION

The present application is based on and claims the benefit of priority of Japanese Patent Application No. 2010-191026, filed on Aug. 27, 2010, the disclosure of which is incorporated herein by reference.

### TECHNICAL FIELD

The present disclosure generally relates to a battery management system to manage a battery that supplies an electric power for a battery-driven device.

### BACKGROUND INFORMATION

Japanese Patent 2009-254123 (JP '4123) discloses an anti-theft process of the battery-driven device that operates on an electric power of a battery and a charge process in case of emergency. In the above disclosure, the anti-theft process automatically sends a report to a police when someone tries to charge a battery in the battery-driven device that is in a stolen condition. On the other hand, when a user cannot be authenticated, the battery may be charged but only when a public organization such as a police admits necessity of charging in view of a emergency. In this manner, illegal charging of the battery is prevented. Further, in case of emergency, the charging is permitted under a strict security control. Therefore, the battery-driven device can be charged regardless of user authentication.

In addition, Japanese Patent 2007-282471 (JP '2471) suggests an authentication process to authenticate a battery. In the conventional technique, charge is prohibited when the authentication is not established for some reason. The charge prohibition by the authentication failure is raised only in case of emergency. However, various kinds of factors are included in the cause of authentication failure. Therefore, granting the charging in case of emergency only in the conventional technique may greatly damage user convenience. For example, the battery-driven device could not be operated by the user, even when the user wanted to operate the battery-driven device, with sufficient knowledge of the cause of authentication failure and with an intention to resolve the cause.

### SUMMARY OF THE DISCLOSURE

In view of the above and other problems, the present disclosure provides a battery management system that restricts use of a non-compliant battery while improving user convenience and/or experience.

Other objectives of the battery management system in the present disclosure include permitting a charge to the non-compliant battery based on user decision, without permitting a free use of the non-compliant battery.

The present disclosure adopts following techniques to achieve the above objectives.

In an aspect of the present disclosure, a battery management system includes: a battery-checker that determines if a battery in a battery-driven device is compliant or non-compliant: a charge grant unit that grants a permission to charge; a charge permission checker that determines whether the permission to charge was granted; a control unit that controls the charging of the battery. Further, the control unit includes a charge unit that charges the battery when (a), the battery-checker determines that the battery is compliant or when (b) the battery-checker determines that the battery is non-compliant and the charge permission checker determines that the permission to charge was granted. Further the control unit further includes a restriction unit that restricts the charging of the battery when the battery-checker determines that the battery is non-compliant and the charge permission checker determines that the permission to charge was not granted.

According to the above configuration, the user can acquire a permission to charge by registering predetermined information in order to charge the battery that is non-compliant. When the permission to charge is acquired, the non-compliant battery can be charged. Therefore, the battery-driven device which has a non-compliant battery can be put in a usable condition. On the other hand, when the permission to charge is not granted charge to the non-compliant battery is restricted. In this manner, user convenience is improved while restricting the use of the non-compliant battery.

Further, the charge permission checker is configured to determine whether the permission to charge is valid of not valid. According to this configuration, the charging of the non-compliant battery is permitted only when the permission to charge is granted and is valid.

Further, the charge permission checker determines that the permission to charge is not valid when a number of charges permitted have been exceeded or when a time period in which the permission to charge is valid has passed. Further the charge permission checker determines that the permission to charge is valid when the number of charges permitted has not been exceeded or when the time period has not passed. According to this configuration, charging of the non-compliant battery can be temporarily permitted. Therefore, use of the non-compliant battery can be restricted effectively.

Further, an information provision unit for providing the required information registered by the charge grant unit to a related organization that is related to one of the battery and the battery-driven device. According to this configuration, the related organization can be notified that charging of the non-compliant battery is being permitted.

Further, the charge unit may include a compliant battery charger that charges the battery when the battery is compliant without checking if the permission to charge was granted. Further, the charge unit may include a non-compliant battery charger that charges the battery under a restricted charge condition that is different from a charge condition used by the compliant battery charger when (a) the battery is determined to be non-compliant by the battery-checker and (b) the charge permission checker determines that the permission to charge was granted. According to this configuration, the non-compliant battery is charged under a restricted charge condition that is more restricted than a charge condition for a compliant battery. Therefore, damage to the battery-driven device and/or the battery due to use/charge of the non-compliant battery is prevented.

Further, the charge permission grant unit includes an input terminal that is operated by a user of the battery-driven device; a server for granting the permission to charge; and the user provides required information to the server through the input terminal, the server grants the permission to charge when the information provided by the user is valid and legal. According to this configuration, a grant process of a charge permission can be performed between an input terminal and a server.

### BRIEF DESCRIPTION OF THE DRAWINGS

Objects, features, and advantages of the present disclosure will become more apparent from the following detailed description made with reference to the accompanying drawings, in which:

FIG. 1 is a block diagram a battery management system;

FIG. 2 is a block diagram of a vehicle part of the battery management system of FIG. 1;

FIG. 3 is a flowchart of control of the battery management system;

FIG. 4 is a flowchart of control of the battery management system;

FIG. 5 is a flowchart of control of the battery management system;

FIG. 6 is a flowchart of control of the battery management system;

FIG. 7 is a flowchart of control of the battery management system; and

FIG. 8 is a flowchart of control of the battery management system.

### DETAILED DESCRIPTION

In the following, is described with reference to the drawing.

### First Embodiment

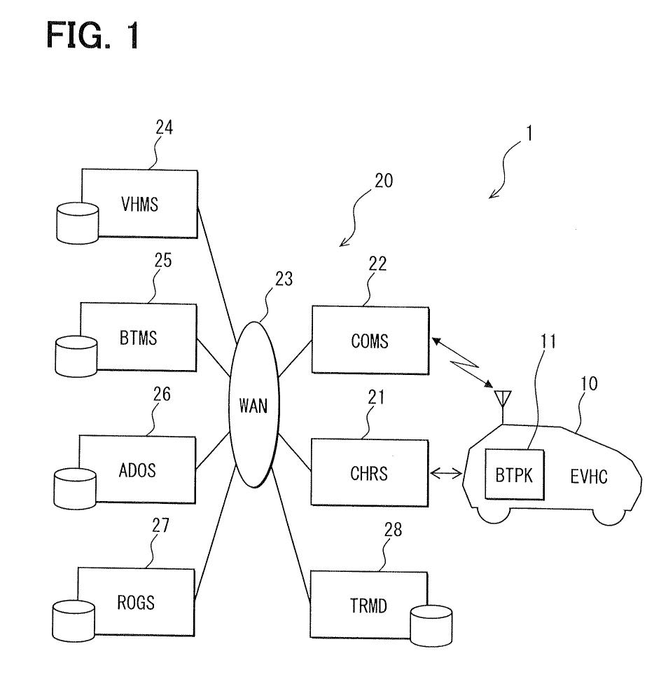

With reference now to FIG. 1 a battery management system 1 comprises a vehicle (EVHC) 10 and a ground facility 20 disposed on the ground. The vehicle 10 is a battery-driven device operated by a battery 11. The vehicle 10 generates at least a part of its driving power by using a motor. For example, the vehicle 10 may be a battery car driven only by a motor, or a hybrid car in which an internal combustion engine is used together with the motor.

The ground facility 20 includes a charge station (CHRS) 21 and a communication facility (COMS) 22. The charge station 21 includes a charger for charging the battery 11 in the vehicle 10 and a data communications equipment to connect to a wide area network (WAN) 23. The communication facility 22 is a communications equipment of a communication company, and is wirelessly communicable with communication equipment in the vehicle 10. For example, the communication facility 22 is a ground station of a mobile telephone service company. The communication facility 22 includes a data communications equipment to connect to WAN 23. WAN 23 serves as a communication line. For example, WAN 23 is provided through Internet.

The ground facility 20 also includes a server of vehicle manufacturers (VHMS) 24, a server of battery manufacturers (BTMS) 25, a server of administrative organization (ADOS) 26, and a server of related organizations (ROGS) 27, which may be referred to as servers 24, 25, 26, 27 or the like. Servers 24, 25, 26, 27 are connected to WAN 23. The components of the ground facility 20, that is, charge station 21, the communication facility 22, the server 24, 25, 26, 27, are in mutual communication through WAN 23.

The ground facility 20 may be equipped with an input terminal 28. For example the input terminal 28 may be a personal computer connectable to WAN 23, a portable terminal, or a cellular phone. The input terminal 28 is connectable to the server 24, 25, 26, 27 in the ground facility 20. That is, for example, through communication to the server ADOS 26, the input terminal 28 sets, modifies, or initializes information regarding authentication of the battery 11, together with other processes. The input terminal 28 may be provided as a navigation apparatus including a display unit 15 on the vehicle 10.

The server 24, 25, 26, 27 each include a recording device for recording information provided from WAN 23. The contents of the recording device can be used by the individual servers, and can also be read by a third party. The server VHMS 24 can be read by a manufacturer of the vehicle 10. The manufacturer of the vehicle 10 is an organization related to a battery-driven device, and may be designated as a responsible organization which is responsible for the vehicle 10. The server BTMS 25 can be read by a manufacturer of the battery 11. The manufacturer of the battery 11 is an organization related to the battery, and may be designated as a responsible organization that is responsible for the battery 11.

The responsible organization(s) may be responsible for product liability, a service provision obligation for providing a service that is designated in a contract paper, a social responsibility for preventing an accident and providing relief, together with other responsibilities. For example, the vehicle manufacturer of the vehicle 10 and the battery manufacturer of the battery 11 are considered to bare a few responsibilities regarding their products and its use.

The server VHMS 24 of the vehicle manufacturer has a recording device for recording information provided from WAN 23. The contents of the recording device can be used in the server VHMS 24, and can be read by a manufacturer of the vehicle 10. The server BTMS 25 of the battery manufacturer has a recording device for recording information provided from WAN 23. The contents of the recording device can be used in the server BTMS 25, and can be read by a manufacturer of the battery 11.

The server ADOS 26 can be read by an administrative organization. The administrative organization is an organization related to a battery-driven device or a battery. The administrative organization may be a public organization for substantially administering the responsible organization that is responsible for the vehicle 10 or the battery 11. The public organization includes an organization belonging to a national government or a local government, such as, a governmental organization controlling road traffic, a governmental organization controlling a consumer safety, or the like. The public organization may include a “substantially” public organization, such as, a product authentication organization for authenticating a product such as a battery that has passed a quality test, a performance test or the like. Such an organization may include a non-governmental organization related to a traffic safety or a consumer safety, a non-profit organization, or a corporation. For example, the public organization includes an organization providing security for the vehicle 10 or the battery 11, an insurance company for providing insurance for the vehicle 10 or the battery 11, and an organization for organizing a vehicle user membership. The public organization may further include a non-profit organization that promotes a vehicle safety through public advertisement. These public organizations directly or indirectly control and substantially administer the responsible organizations. That is, the governmental organization controls and administers the vehicle manufacturers and the battery manufacturers based on applicable laws and regulations. Further, the companies and corporations as well as non-profit organizations may also control and administer, through advertisement and information communication to the public, the vehicle manufacturers and the battery manufacturers.

The server ROCS 27 may be read by a related organization, which is an organization related to the vehicle 10 and the battery 11. For example, the related organization may include a police department, an organization related to credit information of the user of the vehicle 10 that provide authentication for personal information of the user, an insurance company providing insurance for the vehicle 10 or the battery 11 may be included in the related organization, or the like.

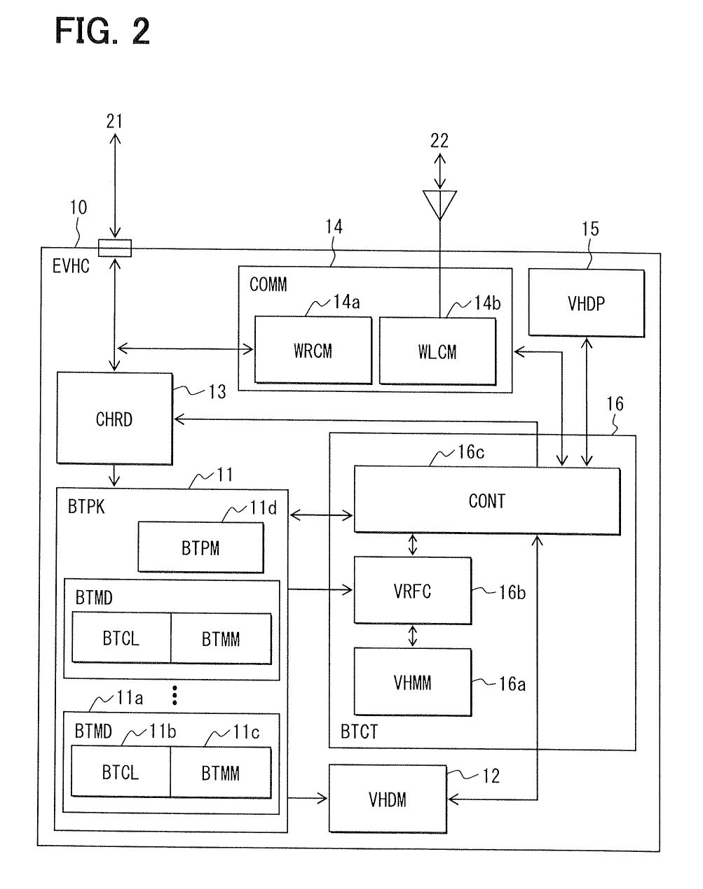

FIG. 2 is a block diagram of a vehicle part disposed in the vehicle 10 of the battery management system 1. In the battery management system 1, the battery 11 is installed in the vehicle 10. The battery 11 may be referred to as battery package (BTPK) 11. The battery package 11 has a plurality of battery modules (BTMD) 11a installed thereon. Each of the battery modules 11a is replaceable. The battery module 11a includes a battery cell (BTCL) 11b and a memory device (BTMM) 11c. The battery cell 11b is a basic component of the battery 11. The battery cell 11b may be a lithium ion battery. The memory device 11c is a part of the battery 11, which cannot be removed from the battery module 11a without breaking it. The memory device 11c memorizes authentication information to authenticate the battery module 11a. The authentication information may include identification information (ID) of the battery module 11a and management information. The identification information may include a code showing that the battery module 11a is a genuine battery and a code showing that the battery module 11a is distributed to an authorized distribution channel. The management information is for managing a use of the battery module 11a compliant to a specification. That is, the management information specifies a warranty period, a maximum number of use, a charge condition, a discharge condition, and the like of the battery module 11a. The memory device 11c memorizes security information related to the battery 11.

Further, the battery package 11 includes a storage device (BTPM) 11d. The storage device 11d memorizes management information about the whole battery package 11. The management information specifies a warranty period, a charge condition, a discharge condition, and the like of the whole battery package 11. Further, the charge condition of the whole battery package 11 specifies, as a condition of restricted charging, a restricted charge amount and a restricted number of charging.

In the vehicle 10, a genuine battery specified by a vehicle maker or a non-genuine battery that is compatible with the genuine battery may be used as the battery 11 or the battery module 11a. For example, the “genuine” battery may indicate a battery that is specified by a maker of the vehicle 10, or a seller of the vehicle 10. Further, the “genuine” battery may indicate a battery that is specified by both the maker of the vehicle 10 and the maker of the battery 11 as a suitable battery for use in the vehicle 10. Furthermore, the “genuine” battery may indicate a battery that is specified by an organization of the makers of the vehicle 10 and/or the makers of the battery 11. The “genuine” battery may include a near-genuine battery that is specified by a public organization, or a near-genuine battery that is specified by an organization of makers and/or sellers. In other words, a battery is proven to be “genuine” not by a label on the battery but by a battery authentication performed by a computer in the vehicle 10.

The non-genuine battery means batteries without warranty, or without authentication by a reliable organization. Those batteries may be designated as a non-compliant battery. The non-genuine batteries may or may not have recorded information on a responsibility of the product (e.g., a product liability), which can be readable by a computer, for identifying a person, a company, or an organization in charge of the battery. Those non-genuine batteries cannot be authenticated by a computer in the vehicle 10. The non-genuine battery may be called as a third party product, or a copy product.

The battery 11 is not considered as “properly-functioning” when the warranty period is expired, or when the maximum times of use is surpassed. That is, even when the battery 11 is a genuine one, the warranty-expired battery or the surpassed max-use-time battery is not considered as “properly-functioning”, and may also be referred to as an “improper battery”. The improper battery are batteries that are not in proper use condition, or are in a no-guarantee condition for use, which may also include a battery that may be broken. The properly-functioning battery can be authenticated by a computer in the vehicle 10. The properly-functioning battery may also be referred to as a proper battery or the like. An improper battery may also be referred to as not properly-functioning battery or the like.

Further, a legally-acquired battery and an illegally-acquired battery are included in a category of the genuine battery. The legally-acquired battery is acquired via an authorized distribution channel, and installed in the vehicle 10 by an authorized procedure. The illegally-acquired battery is a battery acquired illegally from an un-authorized channel or the like. For example, stolen products are categorized as an illegally-acquired battery. The legally-acquired battery can be authenticated by a computer in the vehicle 10.

A “compliant” battery means that a battery is (a) a genuine one, (b) a properly-functioning one, and (c) a legally-acquired one. A non-compliant battery means that a battery is either (d) a non-genuine one, (e) a not properly-functioning one, or (f) an illegally-acquired one. In other words, when a battery is expressed as “compliant” or “normal”, the battery is a genuine one, a properly-functioning one, and a legally-acquired one. When a battery is expressed as “non-compliant” or “abnormal”, the battery is either a non-genuine one, not properly-functioning one, or an illegally-acquired one.

The vehicle 10 has a drive mechanism (VHDM) 12 installed therein. The drive mechanism 12 drives the vehicle 10 on electricity supplied from the battery 11. The drive mechanism 12 includes an electric motor. Further, the drive mechanism 12 may include an internal combustion engine generating a driving power of the vehicle 10.

The vehicle 10 has a charge device (CHRD) 13 installed therein. The charge device 13 controls charging of the battery 11. When the vehicle 10 is connected to the charge station 21 by a charge line, the charge device 13 controls the charging of the battery 11 by the charge station 21. The charge device 13 may have a breaker for permitting and prohibiting the charging of the battery 11 according to an input signal from outside of the charge device 13. The charge device 13 may have a charge amount control unit for controlling the amount the battery 11 is charged. According to the input signal, the charge amount of the battery 11 is controlled to a certain amount between a minimum charge amount and a maximum charge amount according to the input signal.

The vehicle 10 has a communication device (COMM) 14 installed therein. The communication device 14 is in communication with at least one server through a wired connection or a wireless connection. The communication device 14 includes a wired communication device (WRCM) 14a communicating with the charge station 21 through a charge line. Further, the communication device 14 includes a wireless communication device (WLCM) 14b communicating wirelessly with the communication facility 22 through a cellular phone network. The communication device 14 transmits data to an outside server, (i.e., a memory device outside of the communication device 14), through one of the wired communication device 14a or the wireless communication device 14b. The communication device 14 is in communication with at least one of the server VHMS 24 of the vehicle manufacturer and the server ADOS 26 of the administrative organization.

The vehicle 10 has a display unit (VHDP) 15 installed thereon. The display unit 15 displays a message for the user, such as a driver of the vehicle 10. In addition, the user of the vehicle may mean an owner of the vehicle, a manager of the vehicle, a driver of the vehicle, or a passenger of the vehicle. The display unit 15 may be provided as a meter unit, a navigation unit, or an imaging device on the vehicle 10.

The vehicle 10 has a battery control unit (BTCT) 16 installed thereon. The battery control unit 16 is provided as a microcomputer equipped with a computer-readable storage medium. The storage medium stores a computer-readable program. The storage medium may be provided as a memory. The program may be executed by a control unit for controlling the battery control unit 16 to be serving as a device described in this specification. The battery control unit 16 further includes a memory unit (VHMM) 16a, an authentication unit (VRFC) 16b and a control unit (CONT) 16c. These components 16a, 16b, 16c may be provided as a microcomputer circuit and a program executed therein.

The battery control unit 16 controls the battery 11, the drive mechanism 12 and the charge device 13 so that the battery 11 is used properly. The battery control unit 16 is configured to perform the above-described control according to a condition of the battery 11. The battery control unit 16 further performs an authentication control to restrain the use of a non-compliant battery, while preventing inconvenience of to user. The battery control unit 16 has a battery-checker for checking whether a battery is compliant to a maker-specified requirement. Further, the battery control unit 16 controls the charge device and/or the drive mechanism according to a check result of the battery-checker and a transmission unit for sending out relevant information through a communication channel according to the check result of the battery-checker. The above-described function units of the battery control unit 16 may be called as function blocks or modules.

A battery management system 1 includes, as a main component, the battery control unit 16 that may be installed in the vehicle 10. A part of the battery management system 1, such as the battery-checker of the battery control unit 16, can be included in the ground facility 20. Further, information indicative of the use of a non-compliant battery may be configured to be relayed by a plurality of servers, to be stored in an intended recording device. In such a configuration, a part of the transmission unit is installed in the ground facility 20.

The memory unit 16a of the battery control unit 16 memorizes authentication information to authenticate the battery 11. The authentication information, which may also be referred to as the maker-specified requirement, may include a code to authenticate a genuine battery, a code to authenticate a properly-functioning battery, and a code to authenticate a legally-acquired battery.

An authentication unit 16b of the battery control unit 16 serves as the battery-checker for checking whether the battery is compliant or non-compliant based on whether the battery is genuine, properly-functioning, and legal. The authentication unit 16b includes a reader unit for reading the identification information and the management information from the battery 11 as well as a retrieval unit for retrieving the authentication information memorized in the memory unit 16a. The authentication unit 16b determines whether each of the battery modules 11a is compliant or non-compliant.

The authentication unit 16b includes means to determine whether a battery is a genuine or non-genuine battery based on the authentication information and the identification information. The authentication unit 16b determines whether a battery is genuine for each of the battery modules 11a. The determination of whether a battery is a genuine or non-genuine can be determined using various techniques. For example, predetermined identification information is issued only for a genuine battery. The manufacturer of the battery 11 stores the issued information to the memory device 11c. The authentication information is registered in the memory unit 16a. When the identification information accords or is the same as the authentication information, the authentication unit 16b authenticates the battery 11 as a genuine one. When the identification information is not the same as the authentication information, the authentication unit 16b authenticates the battery 11 as a non-genuine one. When the battery module 11a is disposed in the vehicle 10, a code, which should be the same as the identification information, may be registered in the memory unit 16a as the authentication information. By employing a particular procedure or a particular device for reading the identification information from the memory device 11c or for registration of the authentication information in the memory unit 16a, unauthorized registration is prevented. In another technique, the genuine battery may have the identification information issued with a predetermined encrypting code. The manufacturer of the battery 11 stores the issued identification information to the memory device 11c. The memory unit 16a has a code registered therein as the authentication information for decrypting the identification information. The authentication unit 16b decrypts the identification information by using the registered authentication information, and the decrypted information authenticates the battery as a genuine one when the decrypted information is an expected one. Furthermore, in yet another scheme, predetermined identification information is issued only for a genuine battery. The authentication unit 16b accesses the server ROGS 27 of the related organization through the communication device 14, and determines whether the identification information is of a genuine battery. In this case, the battery-checker is realized as a combination of the authentication unit 16b and the server ROGS 27. The authentication scheme of the genuine battery based on the identification information may be implemented by employing various authentication techniques.

Based on the management information the authentication unit 16b includes a means for determining whether a battery is properly functioning or not properly-functioning. The authentication unit 16b determines whether a battery is properly-functioning for each of the battery modules 11a. The determination whether or not a battery is properly-functioning can be carried out by the following process. The memory device 11c memorizes warranty information indicative of a warranty period of the battery 11 the management information. The authentication unit 16b determines whether the warranty period has expired. If the warranty period has not expired, the battery 11 is determined as properly-functioning or proper. If the warranty period has expired, the battery 11 is determined as not properly-functioning or improper and is non-compliant. In another process, the memory device 11c memorizes information indicative of a maximum number of charge operations as the management information. The authentication unit 16b determines whether the maximum number of charge operations is surpassed. If the maximum number of charge operations is not surpassed, the battery 11 is determined as properly-functioning. If the maximum number of charge operations is surpassed, the battery 11 is determined as not properly-functioning or improper and as is non-compliant.

Based on the authentication information and the identification information, the authentication unit 16b includes means to determine whether a battery is a legally-acquired or an illegally-acquired battery, and does so for each of the battery modules 11a. The determination whether or not a battery is a legally-acquired battery can be carried out by the following process. A predetermined identification information is issued only for a genuine battery supplied to an authorized distribution channel. The manufacturer of the battery 11 stores the issued identification information to the memory device 11c. When the battery module 11a acquired via the authorized distribution channel is installed in the vehicle 10, predetermined and authorized registration processing is carried out. By the registration processing, the authentication information same as the identification information is registered to the memory unit 16a. When the identification information accords with authentication information, the authentication unit 16b authenticates the battery module 11a as a legally-acquired product. When it does not, the battery module 11a is an illegally-acquired product and is non-compliant. The authentication process of the legally-acquired battery based on the identification information may be implemented by employing various authentication techniques.

Based on the authentication result by the authentication unit 16b, the control unit 16c controls the battery 11, the charge device 13, and the drive mechanism 12. The control unit 16c may provide means to allow or prohibit charging according to the authentication result, means to limit an electricity charge amount according to the authentication result, and means to restrict travel of the vehicle by using the battery 11 according to the authentication result. When a non-compliant battery is used, the control unit 16c and the communication device 14 serve as a transmission unit for sending out, to the external servers VHMS 24, ADOS 26 through WAN 23, information indicative of the use of the non-compliant battery 11.

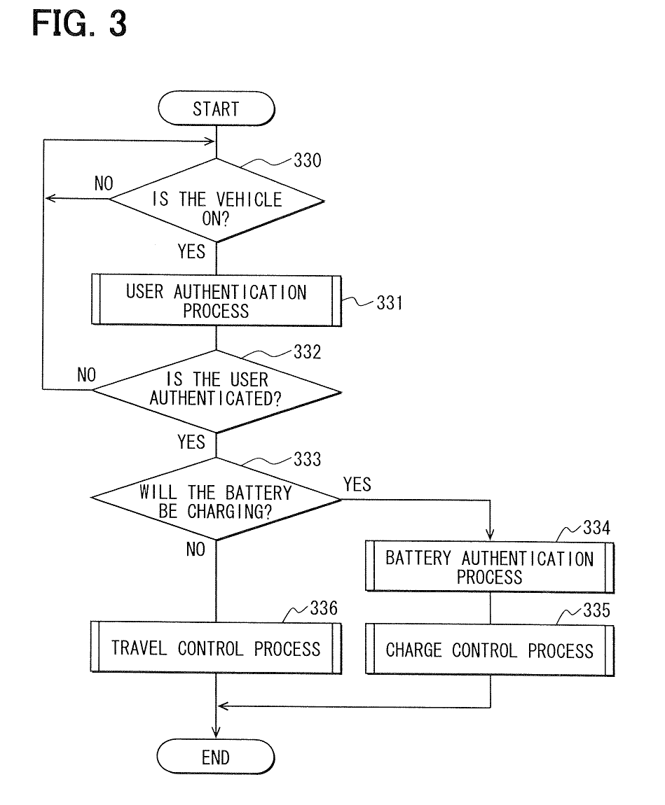

The operation of the battery management system is explained with reference to FIGS. 3 to 8. FIG. 3 is a flowchart showing an operation of the battery management system 1 of the vehicle 10. In step 330, it is determined whether the vehicle 10 has been started. In other words, when an occupant gets in the vehicle 10, it is determined whether or not a power switch of the vehicle 10 is operated to an “ON” position. When it is determined that the use of the vehicle 10 is not started, the process returns to step 330. When it is determined that the use of the vehicle has started, the process proceeds to step 331. In step 331, a user authentication process is carried out to determine whether a person who is going to use the vehicle 10 has proper authority. For example, it is determined whether a key or an electronic code owned by a user has authenticity. In step 332, it is determined whether use of the vehicle 10 is approved by the user authentication of step 331. When use of the vehicle 10 is prohibited, the process returns to step 330. When use of the vehicle 10 is permitted, the process is advanced to step 333.

The user authentication process in steps 330 to 332 is carried out by a security device belonging to the vehicle 10 or an immobilizer belonging to the drive mechanism 12. Note that the user authentication process in step 331 is different from the battery authentication process in later step 333. Security of the battery information is improved by carrying out the battery authentication process after an affirmative determination in the user authentication.

In step 333, it is determined whether the user is going to charge the battery 11. When the user stops the vehicle 10 in front of the charge station 21 and connects a charge line to the vehicle 10, the process proceeds to step 334. In step 334, the battery authentication process is carried out. The battery authentication process is carried out by the authentication unit 16b and the control unit 16c. In step 335, a charge process to charge the battery 11 is carried out. The charge process is carried out by a control unit in the charge device 13. Further, in the charge process, an authentication result in the battery authentication process is referred to, and the charge process is carried out based on the authentication result of the battery authentication.

In step 333, if it is determined that the user is not charging the battery, the process proceeds to step 336. In step 336, a travel control process to use the battery 11 as a power source is carried out. The travel control process is carried out by a control unit in the drive mechanism 12. Further, before the travel control process, the battery authentication process may be carried out. The travel control process refers to the authentication result from the battery authentication process, and the travel control process is carried out based on the authentication result of the battery 11.

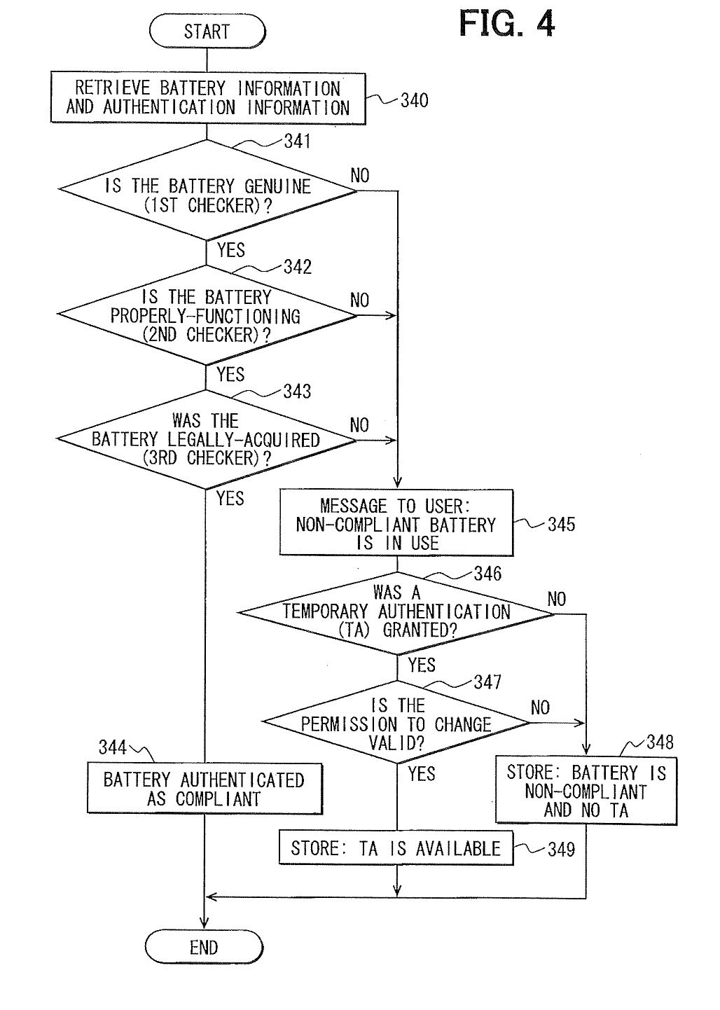

FIG. 4 is a flowchart of the battery authentication process. Steps 340 to 343 serve as a battery-checker that determines whether a battery is a compliant battery or a non-compliant battery. In step 340 identification information and battery information including management information are retrieved from the battery 11. Further, in step 340, the authentication information memorized in the memory unit 16a is retrieved.

In step 341, it is determined whether the battery 11 is a genuine product suitable for the vehicle 10 based on the identification information and the authentication information. For example, this determination can be carried out based on whether a code showing a genuine product is included in the identification information. Step 341 serves as “a first checker” to determine whether a battery is a genuine battery. Step 341 is carried out for each of the battery modules 11a. The process proceeds to step 345 if any one of the battery modules 11a is found to be non-genuine. The process proceeds to step 342 if all the battery modules 11a are genuine.

In step 342, it is determined, based on the management information retrieved from the battery 11, whether the battery 11 is properly-functioning. Step 342 serves as “a second checker” to determine whether a battery is properly-functioning. Step 342 is carried out for each of the battery modules 11a. The process proceeds to step 345 when any one of the battery modules 11a is found to be not properly-functioning. The process proceeds to step 343 if all the battery modules 11a are properly-functioning.

In step 343, it is determined whether the battery 11 is a legally-acquired battery. In other words, it is determined if the battery 11 is acquired via the authorized distribution channel, and it is determined whether the battery 11 is installed in the vehicle 10 by an authorized procedure. For example, this determination can be carried out by determining whether the identification information is associated with the information that is unique to the vehicle 10. Step 343 serves as “a third checker” to determine whether a battery is legally-acquired. Step 343 is carried out for each of the battery modules 11a. The process proceeds to step 345 when any one of the battery modules 11a is found to be illegally-acquired.

If the process determines in step 343 that all the battery modules 11a are legally-acquired, the battery 11 is determined as a normal or compliant battery because it was determined as genuine in step 341, as functionally-proper in step 342, and as legally-acquired in step 343. Thus, in step 344, it is recorded that the battery 11 is a authenticated as compliant. Because the battery 11 is determined as normal or compliant, a normal charge control for the battery 11 and a normal travel control for the vehicle 10 are permitted thereafter.

When the battery 11 is determined as non-genuine in step 341, or as not properly-functioning in step 342, or as illegally-acquired in step 343, the battery 11 is considered to be a non-compliant or an abnormal battery. Therefore, in steps 345 to 348, a determination process is performed for determining the degree of restriction for the charge control.

In step 345 the user of the vehicle 10 is notified of the use of the non-compliant battery 11 by displaying a message to the user on the display unit 15.

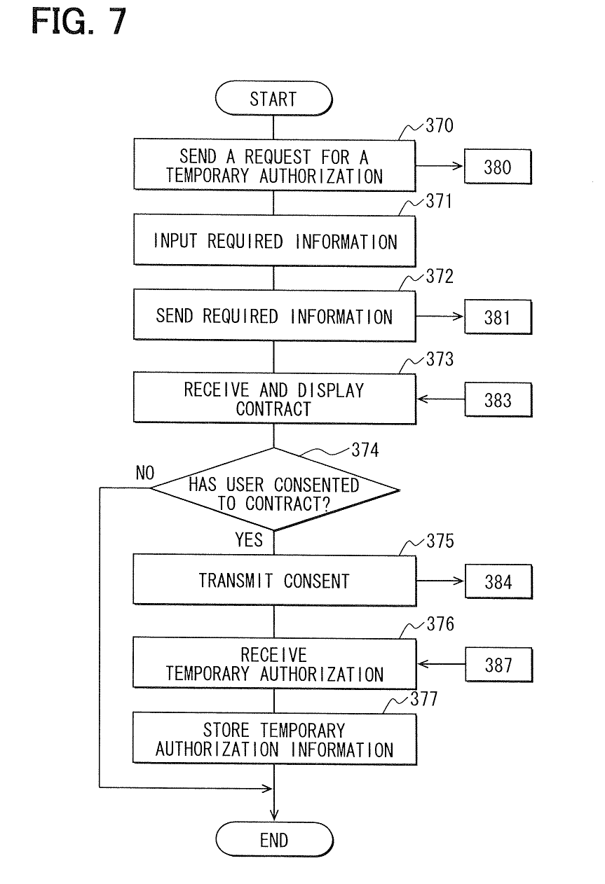

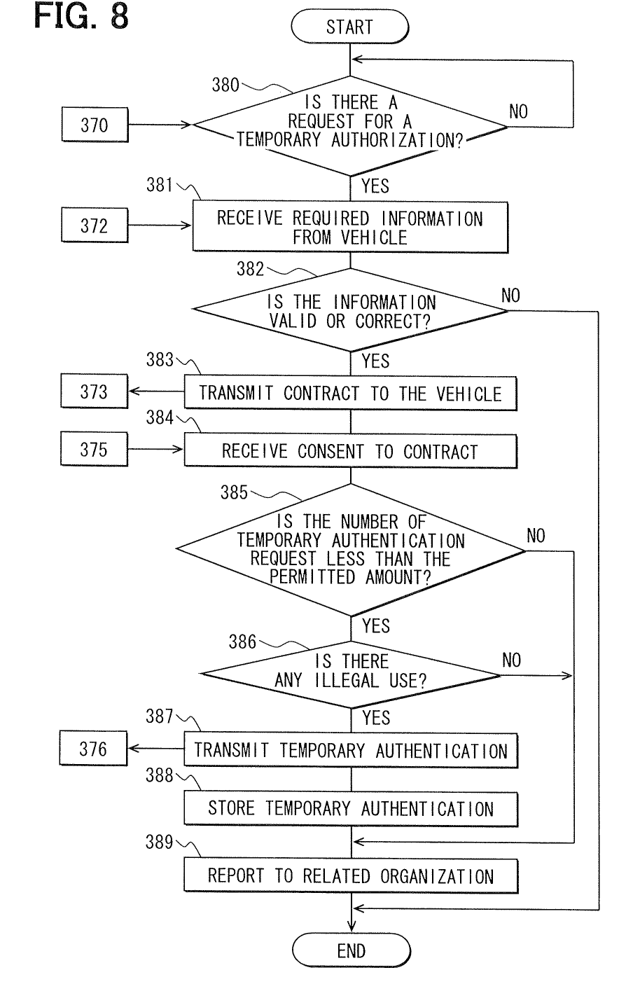

In step 346, the process determines if a temporary authorization has been granted. The user of the vehicle 10 may request the temporary authorization, via the input terminal 28, from the server ADOS 26 of the administrative organization. The temporary authorization may include a permission to charge that permits the user to charge the battery 11, which was found to be a non-compliant battery. The temporary authorization may be granted if certain requirements are met. For example, the temporary authorization may only be granted for a certain vehicle or for a certain battery. Also, the temporary authorization defines the term of use of the permission to charge. That is the permission to charge may only be valid for a certain period of time or may only permit the battery 11 to be charged a certain number of times. If the temporary authorization is granted it is stored in the battery control unit 16. Thus step 346 determines if a temporary authorization is stored in the battery control unit 16. The process of requesting and granting the temporary authorization is described in more detail later and with reference to FIGS. 7 and 8.

The authority to charge the battery 11 based on a determination that the battery 11 is compliant is distinctly different from the authority to charge the battery based on the permission to charge that is provided for in the temporary authorization. For example, the permission to charge based on the temporary authorization may be valid only for one day or may be a week. Or, as another example, the permission to charge based on the temporary authorization may only allow the battery 11 to be charged a certain number of times. When the battery 11 is authenticated as compliant or normal, the ability to charge the battery 11 may be permitted for a few years or the battery 11 may be charged a few thousand times. As described above, the restrictions placed on charging the battery 11 based on the permission to charge of the temporary authorization are clearly stricter, or “heavy,” than the restrictions on charging a battery that is authenticated as compliant or normal.

If the temporary authorization is stored in the battery control unit 16, then the process proceeds to step 347, where the process determines whether the permission to charge is valid. The process determines that the permission to charge is valid when the time period in which the permission to charge remains valid has not expired or when the number of charges permitted under the permission to charge has been reached. Accordingly, the process determines that the permission to charge is not valid when a number of charges permitted have been exceeded or when a time period in which the permission to charge is valid has passed. If the permission to charge is valid the process proceeds to step 349. In step 349, the process records that the temporary authorization is available or has been granted, and includes a valid permission to charge. As stated earlier, the temporary authorization includes the permission to charge, which permits the user to charge the non-compliant battery 11. In other words, the temporary authorization and the permission to charge grants use of the non-compliant or abnormal battery. Thus, steps 340 and 347 serve as a charge permission checker that determines if a battery is permitted to be charged based on the availability of the permission to charge, which is granted by a charge grant unit. Further, the charge permission checker determines the validity of the permission to charge.

When the temporary authorization, which includes the permission to charge, was not granted or if the permission to charge was not valid, the process proceeds to step 348. In step 348, it is recorded that the battery 11 has not been authenticated, that is, the battery is not a compliant battery and that the temporary authorization was not granted. In other words, performing step 348 indicates that the battery 11 is a non-compliant and the permission to charge was not granted. Therefore, a charge function for charging the battery 11 is further restricted. For example, the charging of the battery 11 may be prohibited or may be stricter than the restrictions under the temporary authentication.

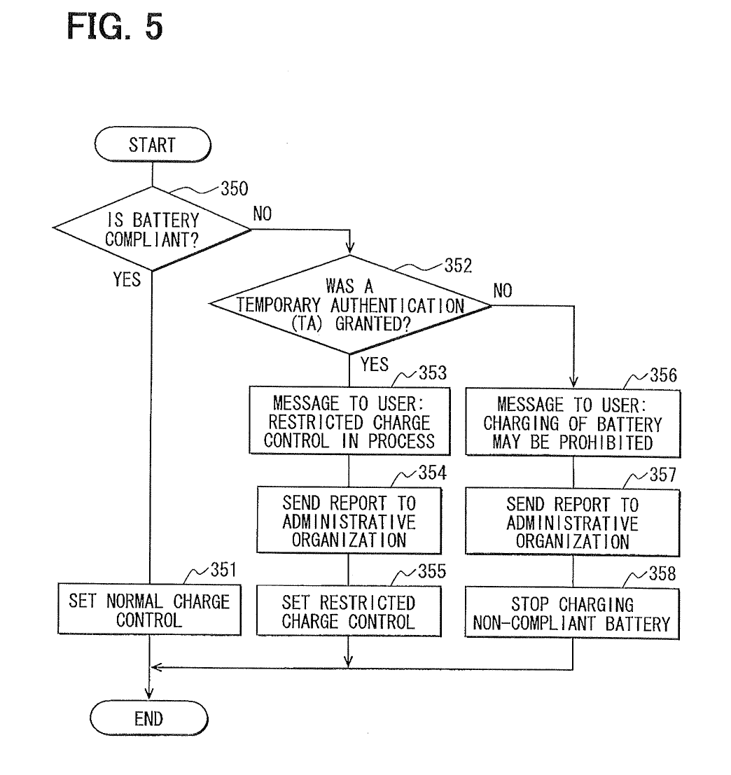

FIG. 5 is a flowchart of a charge control process. The charge control process serves as a control unit, as noted in the claims, that controls the charging of the battery based on a determination result of the battery-checker and a determination result of the charge permission checker.

In step 350, the process determines whether the battery 11 is authenticated as a compliant battery. Step 350 refers to the authentication result recorded in step 344. When the battery 11 has been authenticated as a compliant battery, the process in step 351 performs a normal charge control. Step 351 serves as a compliant battery charger in a charge unit for charging the battery when the battery 11 is a compliant battery, without determining if the permission to charge was granted.

In step 351, charging of the battery 11 is performed unlimitedly, or in a lightly-restricted manner. Step 351 quickly charges the battery 11 by using the charge device 13 to the target charge amount. If the charging is interrupted by the user, the battery 11 may not be charged to the target charge amount. However, the battery 11 is pretty quickly charged to an amount close to full charge by the quick charging. A charge speed of the quick charging is greater than a charge speed of a restricted charging, which is described later. In other words, the charge speed of the quick charging is not limited to a maximum charge speed. Further, the normal charge control in step 351 allows the user to charge the battery 11 to the maximum charge amount granted for the battery 11. That is, when a normal or compliant battery is used, the user can charge the battery 11 unlimitedly in the range of an available charge capacity.

In step 351, the charge device 13 and the control unit 16c monitors a charge condition of the battery 11 at a first monitor interval, for charging the battery 11 according to the monitored charge condition. For example, the electric voltage, as well as the electric current and the temperature, of the battery 11 are monitored at a preset interval. In this manner, the charging of the battery 11 is suitably performed according to the charge condition.

In step 350, when the battery 11 is not authenticated as compliant or normal (i.e. it is non-compliant or abnormal), a restricted charge control is performed in steps 352 to 358. The restricted charge control may include (a) restricting the normal charging, and (b) prohibiting the charging. Steps 353 to 355 serves as a non-compliant battery charger of the charge unit for charging the non-compliant battery 11 under a restricted charge condition that is restricted in comparison to a charge condition for charging a compliant battery, which is used in the charge control by the compliant battery charger.

In step 352, it is determined whether the temporary authorization, which includes the permission to charge, has been granted. This determination is performed by referring to the authentication result recorded in step 348. If the temporary authorization was granted, which permits the charging of the battery 11, then the process proceeds to step 353. If the temporary authorization was not granted, the process proceeds to step 356.

In step 353, the user of vehicle 10 is notified of the performance of the restricted charge control due to use of the non-compliant battery and based on the temporary authorization that permits the charging of the battery 11. The message may be displayed on the display unit 15. Further, the content of the restricted charge control may be displayed on the display unit 15, which may include the restricted charge amount of the battery 11 and/or an estimated travelable mileage. Further, the remaining number of effective charge times under the temporary authorization may be displayed. Step 353 serves as a display unit for displaying that the battery 11 is charged by using the non-compliant battery charger.

In step 354, charging of the non-compliant battery 11 based on the availability of the temporary authorization is reported to the server ADOS 26 of the administrative organization. The information provided to the server ADOS 26 may include information for tracking the vehicle 10, at least one of identification information of the vehicle 10, identification information of the user/driver, identification information of the temporary authorization, identification information of the charge station, and/or identification information of the battery or the like.

In step 355, a lightly-restricted charge control is performed. The lightly restricted charge control may include a low charge speed, a smaller target charge amount, and a restricted number of times the battery 11 can be charged. Step 355 charges the battery 11 by using the charge device 13 at a low charge speed. The charge control at a low charge speed means that charging the battery 11 at a speed that is slower than a charge speed of quick charging in the normal charge control. In other words, the lower charge speed is not limited to the slowest possible charge speed.

The target charge amount set in step 355 may be set to a smaller amount in comparison to the target charge amount set in step 351. For example, the charge amount may be set to drive the vehicle 10 for a certain period of time, or for a certain distance in step 355. The above restriction is set to avoid an excessive inconvenience of the user. That is, the target charge amount may be set to drive the vehicle 10 to, for example, the nearest service station when the battery 11 is determined as non-compliant.

Further, the number of effective charge times may be restricted in step 355. The restricted number of effective charge times may be substantially smaller than the number of effective charge times that is granted or specified for the battery 11 to be bearable. The restricted number of charge times may be set to a number of near-but-non-zero. For example, it may be more than zero and less than ten. The restricted number of charge times is counted for the restricted charge control while the battery 11 remains non-compliant.

In step 355, the charge device 13 and the control unit 16c monitors a charge condition of the battery 11 at a second monitor interval, for charging the battery 11 according to the monitored charge condition. Monitoring at the second monitor interval is more frequent than monitoring at the first monitor interval in step 351. For example, the electric voltage, as well as the electric current and the temperature, of the battery 11 are monitored at a preset interval, which is shorter than the first monitor interval in step 351. If, for example, one of the electric voltage, the electric current and the temperature of the battery 11 indicates abnormality, charging of the battery 11 may slow down, or may be prohibited. In this manner, the charging of the battery 11 is suitably performed according to the charge condition. In addition, more frequent monitoring of the battery 11 condition prevents damage of the battery 11 due to use of the non-compliant battery.

Steps 353 to 355 allow the user to charge the battery 11 under a restricted charge condition. Steps 350, 351, 352, 353, 354, 355 serve as a charge unit that charges the battery 11 when (a) the battery-checker determines that the battery is compliant or when (b) the battery-checker determines that the battery is non-compliant and the permission to charge is granted. Further, steps 353 to 355 serve as the non-compliant battery charger for charging the battery 11 under a restricted charge condition that is stricter than a charge condition used by a compliant battery charger when (a) the check result indicates that the battery 11 is a non-compliant battery, and (b) the permission to charge is granted. By providing the non-compliant battery charger, damage of the battery 11 due to charging of the non-compliant battery is prevented.

When the temporary authorization, which includes the permission to charge, was not granted, the process proceeds to step 356 where the user of the vehicle 10 is notified of the performance of the restricted charge control due to use of the non-compliant battery, where charging of the battery 11 is completely prohibited and the battery 11 will not be charged. The message may be displayed on the display unit 15. In step 357, restricted charging due to use of the non-compliant battery is reported to the server ADOS 26 of the administrative organization. The information provided to the server ADOS 26 may include information for tracking the vehicle 10. The contents of the information are same as the contents of the information in step 354. In step 358 a heavily restricted charge control is performed. Step 358 prohibits the charging of the battery 11 by using the charge device 13. In other words, steps 356 to 358 serve as a restriction unit that restricts the charging to the battery 11 when the battery-checker determines that the battery 11 is a non-compliant battery and the permission to charge was not granted. The restriction unit may be designated as a prohibition unit.

In the present embodiment, the battery 11 can be charged when the battery 11 is a compliant battery. Further, when the battery 11 is a non-compliant battery, the battery 11 can be charged when the temporary authorization and the permission to charge is granted. Further, even when the battery 11 is determined to be non-compliant and the permission to charge, which is part of the temporary authorization, is not granted, the battery 11 can still be charged under a restricted charge condition. Therefore, the battery-driven device is put in an operable/drivable condition even when the non-compliant battery is used, depending on the permission to charge. In other words, the usability of the battery-driven device is improved while restricting the use of the non-compliant battery.

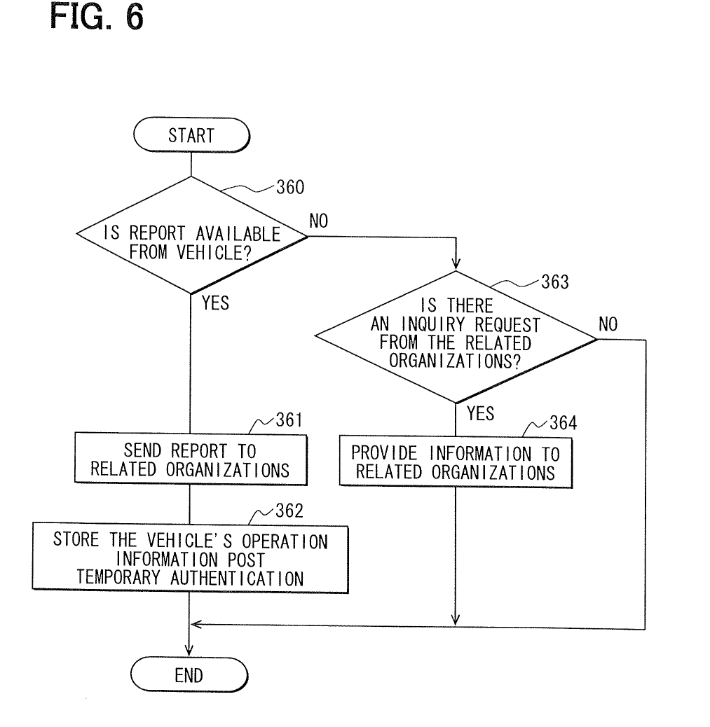

FIG. 6 shows a flowchart of a process in the server ADOS 26 of the administrative organization. This process includes: (i) sharing a report(s) from the vehicle 10 to the related organization, (ii) storing the report(s), and (iii) providing stored report in response to a request from the related organization. The process in the flowchart in FIG. 6 serves as an information provision unit for providing the information registered by the charge grant unit for the related organization, which may be related to one of the battery and the battery-driven device.

In step 360, the process determines whether the vehicle 10 has transmitted a report from step 354 or 357. If the report has been transmitted, the process proceeds to step 361. If the report has not been transmitted the process proceeds to step 363.

In step 361, the process sends the report to the related organizations. Information of the report is transmitted from the server ADOS 26 to the server ROGS 27. The transmitted information is then stored in the server ROGS 27, which can be used by the related organizations. For example, the report may be transmitted to an insurance company. The report(s) from step 354 or 357 indicates use of a non-compliant battery. Therefore, for example, the insurance company may take action for putting the user of the non-compliant battery in a liable condition for running a risk of non-compliance. The above action may be accompanied by a warning to the user. The reporting may also be directed to a police organization. Reporting to the police should benefit an investigation if the non-compliant battery is a stolen one.

In step 362, the server ADOS 26 stores an operation information of the vehicle 10 after the temporary authorization is granted. Such information is stored in the server ADOS 26 in an accumulative manner. The operation information may include information such as a number of charges based on the temporary authorization, identification information of the charge station 21 that is used to charge the vehicle 10, an operation period of the vehicle 10 based on the temporary authorization, and the like.

If no report is received in step 360, then in step 363 the process determines whether an inquiry of information about the temporary authorization and the permission to charge is made by the related organization. The inquiry is transmitted from the server ROGS 27 to the server ADOS 26. If the inquiry exists, the process proceeds to step 364. Step 364 provides information about the temporary authorization to the related organization. For example, the related organization may be a police organization. If the inquiry is from the police organization, the accumulated operation information may be provided to the police organization. The operation information including the charge stations 21 used to charge the vehicle based on the temporary authorization may benefit the investigation by the police organization.

With reference now to FIG. 7 and FIG. 8. FIG. 7 shows a request process of the user requesting, through the input terminal 28, the temporary authorization from the server ADOS 26. FIG. 8 shows an evaluation process of the server ADOS 26 of the administrative organization, which grants the temporary authorization. The administrative organization is an authentication organization that grants the main authentication of a battery and grants the temporary authorization in the battery management system. If the information provided by the user is validated, the user can be granted the temporary authorization that includes the permission to charge.

The temporary authorization request and grant processes are carried out through WAN 23 between the input terminal 28 and the server ADOS 26. The input terminal 28 responds to the operation of the user, and requests for the temporary authorization. The input terminal 28 may be a handheld unit or a navigation apparatus including the display unit 15 on the vehicle 10. Therefore, the user can request for the temporary authorization to allow the user to charge the battery 11 either when the vehicle 10 is about to charge or in advance.

The server ADOS 26 responds to the request from the input terminal 28, and determines whether the temporary authorization should be granted. Also, the server ADOS 26, transmits the temporary authorization to the input terminal 28 to permit the user to charge the battery 11.

The input terminal 28 receives the temporary authorization and the permission to charge, and stores the received temporary authorization in the memory unit 16a of the battery control unit 16. The temporary authorization may be forwarded to the memory unit 16a via a handheld device of the user. In addition, the temporary authorization may be directly forwarded to the memory unit 16a from the server 26.

In step 370, via the input terminal 28, the user requests the temporary authorization from the server ADOS 26. In step 380, the server ADOS 26 determines whether the user has requested a temporary authorization. When there is a request, the process proceeds to step 381. When there is not a request the process returns to step 380.

In step 371, the input terminal 28 provides certain information to the server ADOS 26, which is used to determine if a temporary authorization should be granted. The required information may include: information to identify a subject vehicle, information to identify a user, information of the current battery. Part of the information may be automatically forwarded to the input terminal 28 from the battery control unit 16 of the vehicle 10. Information used to identify the current battery may include an ID number of the battery 11 used in the vehicle 10 or the like. Information to identify the subject vehicle may include a body number, a registration number of the vehicle, or the like. Also information to identify the user may be the user's driver's license number, a social ID number of the user or the like.

In step 382, it is determined whether the information received from the input terminal 28 includes the required information and whether the information is consistent with a standard or if it is valid. In this case, step 382 determines whether a requesting user really exists, whether the user can be trusted, and whether the vehicle 10 really exists. These determinations can be made based on the information in the server ADOS 26. In addition, part of the determination may be carried out cooperatively with the servers 24, 25, 27. For example, a user can determine whether a user really exists, and whether user is trusted, based on customer information memorized from the server VHMS 24 of the vehicle manufacturer. The process of step 382 can be offered by a process to authenticate a user, based mainly on the personal information of the user. The process proceeds to step 383 when the information provided by the input terminal 28 is confirmed or valid. The process goes to the “end” when the information is not confirmed.

Once the information provided by the input terminal 28 is determined to be valid, the server ADOS 26, in step 383, sends a contract to the user, via the input terminal 28, which the user is asked to respond too. In step 373 the input terminal 28 displays the contract to the user. The displayed contract may include a clause regarding risks about using a non-compliant battery. That is, use of the non-compliant battery should be performed at user's risks. The displayed contract may include an escape clause that the vehicle manufacturer or the battery manufacturer is at least partially exempted from responsibility of use of the non-compliant battery. For example, an escape clause showing that a product warranty of the vehicle 10 or the battery 11 may possibly be exempted from application may be displayed. Further, the displayed contract may include a clause that operation information of the vehicle 10 may be provided to a related organization, such as the police organization, the insurance company or the like, which is performed through step 364 in FIG. 6.

In step 374, if the user has given consent to the terms of the contract, the process proceeds to step 375 where the user's consent to the contract is transmitted to the server 26.

In step 384, the server ADOS 26 receives the user's consent to the contract. Once the information provided by the input terminal 28 is affirmed in step 382 and once the user has consented to the terms of the contract in step 384, the temporary authorization of the vehicle 10, the user, and the battery 11 is established. Though temporary authorization is established, it is still necessary to determine if the temporary authorization is sufficient to grant or include the permission to charge. In other words it needed to be determined if the temperature authorization is valid so that the permission to charge can also be granted. The process then proceeds to steps 385 and 386, where the possibility of illegal use is determined. In step 385 it is determined whether restrictions on the temporary authorization have been violated. For example, it is determined whether the user has exceeded a restricted number of requests for a temporary authorization. If the user has exceeded the restricted number of requests, then the process proceeds to step 389. If the user has not exceeded the number then the process proceeds to step 386.

In step 386, it is determined whether the information received in step 381 indicates a sign of illegal use. For example, it is determined as illegal if personal information of the user indicates prohibition of his/her use of a temporary authorization. It is also determined as illegal if the information of the vehicle 10 shows that the vehicle 10 is a stolen vehicle. It is also determined as illegal if the information of the battery 11 shows that the battery 11 is a stolen product. If there is a sign of illegal use the process proceeds to step 389. If there is no sign of illegal use the process proceeds to step 387.

Based on the result that the user has not exceeded the allotted number of temporary authorization request and that the user show no signs of illegal use, the permission to charge can be granted to the user. In step 387, the server ADOS 26 transmits the temporary authorization that includes the permission to charge to the input terminal 28. In step 376, the input terminal 28 receives the temporary authorization. Based on the information provided in step 372 and 381, the temporary authorization provides the permission to charge, which allows the user of the vehicle 10 to charge the battery 11, which was found to be non-compliant, of the vehicle 10. Further, the temporary authorization also includes information regarding the expiration or the duration of validity of the permission to charge, which may be set as a period of time that the user may charge the battery 11 and/or a predetermined number of times the user may charge the battery 11. Once the time period has expired and/or the user has reached the allotted number of times the battery 11 may be charged, then the permission to charge, which is defined by the temporary authorization, is no longer valid or is expired.

In step 388, the server ADOS 26 stores the temporary authorization cumulatively in order to record the number of temporary authorizations issued to the user. The information memorized in step 388 is used in steps 360 to 364 of the process in FIG. 6. In step 389, a grant of the temporary authorization and the permission to charge is reported to the servers 24, 25, 27 of the related organization. In this manner, charging of the battery 11, which is non-compliant, is notified to related organizations such as a vehicle manufacturer, a battery manufacturer or a public organization.

In step 376, the input terminal 28 receives the temporary authorization with the permission to charge, which allows the user to charge the non-compliant battery. In step 377, the input terminal 28 stores the temporary authorization. Particularly, the input terminal 28 may store the temporary authorization with the permission to charge in memory unit 16a of battery control unit 16. The temporary authorization is used in steps 340, 346 of the process in FIG. 4

The request and grant processes of the temporary authorization with the permission to charge described above is based on a on a request from the user. Therefore, the user's convenience in terms of charging the non-compliant battery is improved.

### Other Embodiments

Although the present disclosure has been fully described in connection with preferred embodiment thereof with reference to the accompanying drawings, it is to be noted that various changes and modifications will become apparent to those skilled in the art.

For example, replacing step 355 with step 351 may be possible. In such a modification example, two step charge control in step 351 or 358 can be provided.

Further, in step 358, heavy restrictions on charging may be adopted instead of complete charge prohibition. For example, a charge control that is stricter and more heavily restricted than the charge control in step 355 may be performed. For example, in step 358, only a minimum charge may be permitted. In such a modification example, user convenience is improved while restricting the use of the non-compliant battery in step 358.

Further, for example, when a non-compliant battery is used, charging of only the battery module 11a that is determined as non-compliant may be restricted or prohibited, instead of the restriction or prohibition of the battery 11 as a whole in the above embodiment.

Further, for example, use of a non-compliant battery may be reported as information to the server VHMS 24 of the vehicle manufacturer, to the server BTMS 25 of the battery manufacturer and/or to the server ROGS 27 of the related organization. Furthermore, a means to report to investigation agencies such as a police upon detecting use of an illegally-acquired battery may be provided. Further, the function of the control unit may be provided solely by software, solely by hardware, or by combination of software and hardware. Further, the control unit may be provided as a digital circuit, or as an analogue circuit.

Such changes, modifications, and summarized schemes are to be understood as being within the scope of the present disclosure as defined by appended claims.

What is claimed is:

1. A battery management system comprising:
a battery-checker that determines if a battery in a battery-driven device is compliant or non-compliant;
a charge grant unit that grants a permission to charge;
a charge permission checker that determines whether the permission to charge was granted;
a control unit that controls the charging of the battery;
the control unit includes a charge unit that charges the battery when (a), the battery-checker determines that the battery is compliant or when (b) the battery-checker determines that the battery is non-compliant and the charge permission checker determines that the permission to charge was granted; and
the control unit further includes a restriction unit that restricts the charging of the battery when the battery-checker determines that the battery is non-compliant and the charge permission checker determines that the permission to charge was not granted.

2. The battery management system of claim 1, wherein the charge permission checker determines whether the permission to charge is valid or not valid.

3. The battery management system of claim 2, wherein
the charge permission checker determines that the permission to charge is not valid when a number of charges permitted have been exceeded or when a time period in which the permission to charge is valid has passed; and
the charge permission checker determines that the permission to charge is valid when the number of charges permitted has not been exceeded or when the time period has not passed.

4. The battery management system of claim 1 further comprising:
an information provision unit that transmits a report from the charge grant unit to a related organization, wherein the report includes required information about the battery and the battery-driven device.

5. The battery management system of claim 1 wherein the charge unit further includes:
a compliant battery charger that charges the battery when the battery is compliant without checking if the permission to charge was granted; and
a non-compliant battery charger that charges the battery under a restricted charge condition that is different from a charge condition used by the compliant battery charger when (a) the battery is determined to be non-compliant by the battery-checker and (b) the charge permission checker determines that the permission to charge was granted.

6. The battery management system of claim 1, wherein the charge grant unit further includes:
an input terminal that is operated by a user of the battery-driven device;
a server for granting the permission to charge; and
the user provides required information to the server through the input terminal, the server grants the permission to charge when the information provided by the user is valid and legal.
